(19) United States
(12) Patent Application Publication
(10) Pub. No.: US 2012/0317719 A1
(43) Pub. Date: Dec. 20, 2012

(54) APPARATUS AND METHOD FOR AN EXERCISE MAT

(76) Inventor: Jade Ng, Commack, NY (US)

(21) Appl. No.: 13/528,833

(22) Filed: Jun. 20, 2012

Related U.S. Application Data
(60) Provisional application No. 61/499,092, filed on Jun. 20, 2011.

(51) Int. Cl. A47G 9/06; G09F 3/00

(52) U.S. Cl. 5/417

(57) ABSTRACT

The present disclosure describes an apparatus and method for an exercise mat that includes a first side and an opposed second side. The first side and second side are connected by at least one side edge. The first side has a surface constructed to slip when interfacing with an external support surface and the second side has a non-slip surface. The second side provides a non-slip surface when positioned to interface with the external support surface and with the first side of another mat. The mat is hand portable with size and dimensions limited. The first side has markings that define a base of support for positioning on the mat.

### CROSS-REFERENCE TO RELATED APPLICATION

This application claims priority to provisional application 61/499,092 filed Jun. 20, 2011, the disclosure of which is incorporated by reference herein and made a part of this application.

### BACKGROUND OF THE INVENTION

1. Field of the Invention

The present disclosure relates to the field of devices for exercise mats and in particular to exercise mats that facilitate agility and exercise training

2. Description of the Related Art

Exercise regimens are commonly enhanced by the use of different exercise devices. Different people use different exercise devices to achieve goals in the areas of flexibility, agility, increasing cardiovascular endurance, reactivity, power, balance, toning, high intensity interval training and strength. Some of these devices include the stair steps, agility ladders, grids, glides, sleds, cones, plyometric devices, balance mats, fitness rings, balls and agility dots. Most of these devices are specialized devices for achieving specific agility or exercise goals, but some, such as the ball, can be used to complement a range of specialized exercises. Still, there are inherent structural limitations to these devices that result in many individuals or facilities procuring an excessively large number of different training devices to fulfill the full range of exercise requirements demanded by their users. Further, the structural limitation of these devices in many instances inhibits their flexibility and ability to achieve improved training techniques as well as address broader applications for physical therapy. A training device and method is needed that is readily hand portable, unique in its ability to augment exercise training and revolutionary in its ability to facilitate a broad range of applications such as physical therapy as well as agility and exercise training for a broad range of ages from preschool to elderly.

### SUMMARY OF THE INVENTION

The exercise mat facilitates a broad range of exercise training The exercise mat includes a first or upper side that provides a comfortable surface for exercise that can also slip on external support surfaces such as a common floor and a second or bottom side that is non-slip. The mat is resilient and provides a reduced impact interface for a user. The first side includes markings that define a base of support for exercising. The base of support position is defined by a first marking that includes a first and second indicia that positions the feet of the user centrally on the mat and approximately six (6) to approximately eight (8) inches apart. The base of support can be an initial position before exercise, an interim position or a final position at the completion of the exercise.

The first side also includes a second marking that includes a third and a fourth indicia for the positioning of two hands. The third and fourth indicia of the second marking have a wider separation that approximates positioning the hands at a comfortable distance that is less than and/or approximates shoulder width apart. The mats can be positioned horizontally on a surface to form an array of mats that can be continuous or interrupted by gaps depending upon the desired training evolution. The mats can also be stacked vertically and the non-slip second side provides a non-slip interface to the first side of the mat. The mats are also readily hand portable and can be positioned together for a broad range of personal exercise training such as cross training, calisthenics and yoga.

### BRIEF DESCRIPTION OF THE DRAWINGS

The foregoing and other features of the present invention will become more apparent upon consideration of the following description taken in connection with the accompanying drawings wherein:

FIG. 1 is a perspective view of an exercise mat constructed in accordance with the present disclosure, a user of the exercise mat positioned thereon;

FIG. 2 is a top plan view of the exercise mat of FIG. 1 that depicts a plurality of markings to facilitate the positioning of feet and/or hands as well as various exercises;

FIG. 3 is a front, side and top perspective view of a second embodiment of the exercise mat of FIG. 1 that shows the user exercising with two mats, one foot of the user is positioned on a first side of the mat and the other foot of the user is positioned on a second side of the mat;

FIG. 4 is a front, side and top perspective view of a plurality of the exercise mats of FIG. 1, the mats aligned in a row in fixed spaced separation, the mats selectively positioned as a single mat and as multiple mats stacked on top of one another;

FIG. 5 is a front, side and top perspective view of a plurality of the exercise mats of FIG. 1, the mats positioned with adjoined edges to define a horizontal array of mats; and

FIG. 6 is a front, side and top perspective view of a plurality of the exercise mats of FIG. 1, the mats aligned in a row with a first mat, a center stack of mats and a third mat.

### DETAILED DESCRIPTION OF THE INVENTION

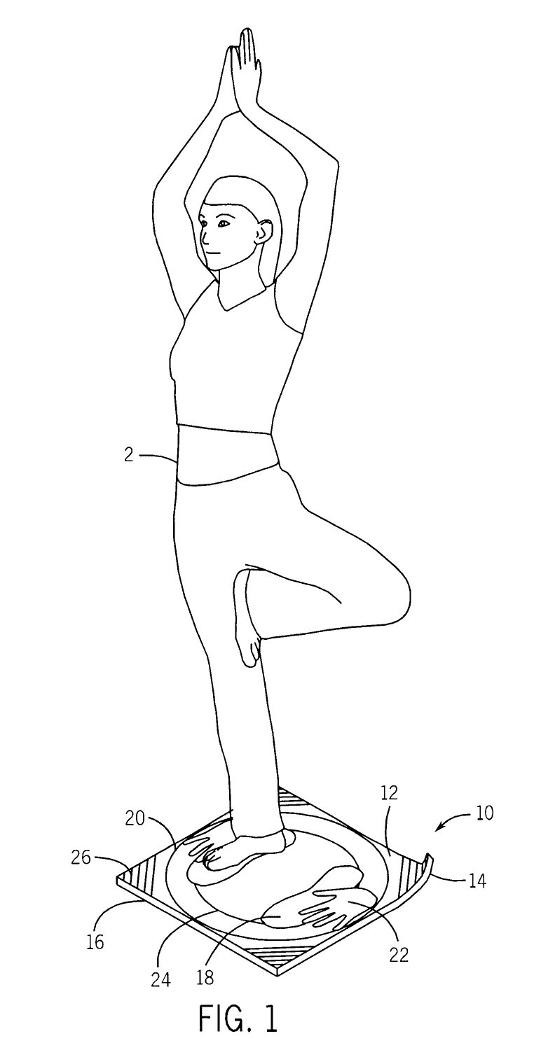

Referring initially to FIG. 1, the present disclosure is directed to an apparatus and method for an exercise mat. The exercise mat 10 has a planar shape that includes a first side 12, a second side 14 and at least one edge 16. The first side 12 and the second side 14 preferably define flat approximately planar surfaces. Exercise mat 10 has a first position in which first side 12 defines an upwardly directed surface and second side 14 is directed downwards towards an external support surface such as a floor.

Mat 10 is a resilient impact absorbing structure that includes a first layer and a second layer. The first layer is a thin sheet that includes first side 12. The first layer is the primary interface to user 12. In the preferred embodiment, first layer 12 is fabricated of one or more of man made materials, natural materials or blend of man made and natural materials. The second layer is a dense resilient foam that includes second side 14. The second layer is bonded to the first layer. Second layer 14 is the primary impact-absorbing layer of mat 10.

Mat 10 is constructed to have limited dimensions for ease of portability and flexibility in training As shown, mat 10 has a dimension along the axis-Y of Y′ and a dimension along the axis-X of X′. In the preferred embodiment, the dimensions Y′ and X′ are identical, define a square and preferably range between approximately twelve (12) inches and twenty-four (24) inches. It is understood, however, that mat 10 can have edges 16 that define any shaped perimeter, such as, but not limited to circular, oval, polygonal or ornamental such as a depiction of an animal or plant. In the preferred embodiment, mat 10 is a square with approximately fifteen (15) inch sides and a thickness that ranges between approximately three-eights (⅜) and two (2) inches. For references purposes only, a first central axis-Y and a perpendicular second central axis-X are located on mat 10. Axis-Y defines generally anterior and posterior directions and axis-X defines generally lateral directions. The intersection of axis-Y and axis-X defines a center of mat 10.

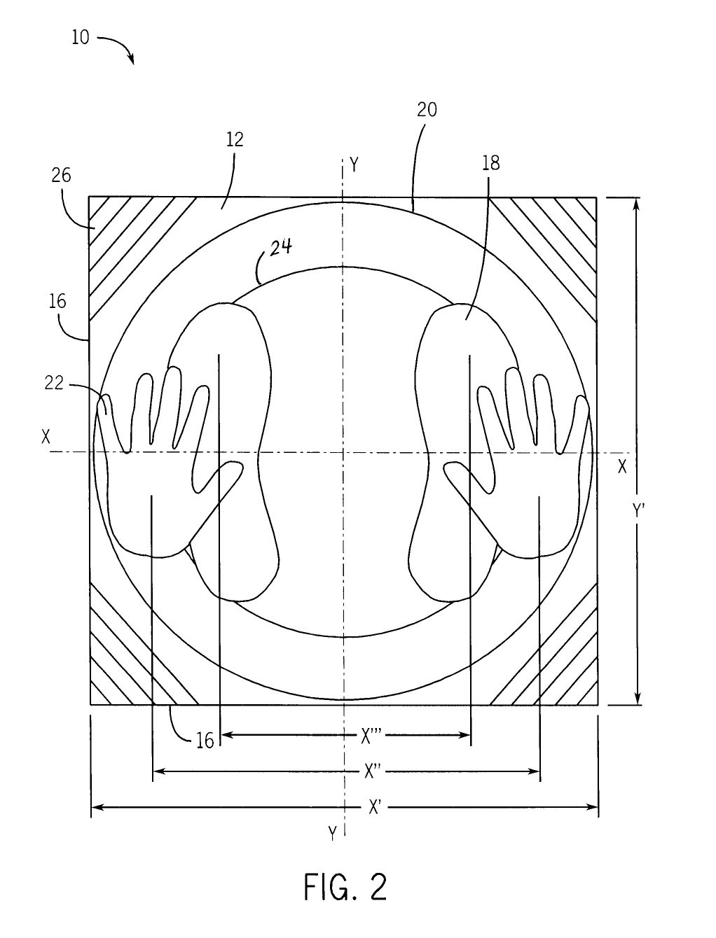

As shown in FIGS. 1 and 2, first side 12 includes a marking 18 that defines a base of support position. Marking 18 includes a first indicia and a second indicia that are graphics with defined locations on mat 10. The first indicia and second indicia define centerlines that are approximately aligned with and positioned a distance X″′ apart. In the preferred embodiment, the distance of X″′ is approximately three (3) to approximately four (4) inches equidistant from first central axis-Y. The base of support is defined by the first and second indicia of marking 18. The base of support locates an initial position before exercise, but can also be used to facilitate exercise on mat 10, an interim position during exercise and/or a final position at the completion of the exercise.

The first and second indicia of marking 18 are preferably idealized elongate shapes or graphic representations that identify the location of a left foot and a right foot in the base of support position. Marking 18 can be any type of graphic that functions to guide user 2 to position their feet to the base of support position. For example, the graphics of marking 18 can include symbols, one or more lines or line segments approximately aligned with axis-Y, an animal footprint such as a human footprint and/or a footprint of any type of foot covering or shoe.

A circle 20 is positioned on first side 12 of mat 10 with a center at the intersection of axis-Y and axis-X. Circle 20 preferably has a diameter that ranges between approximately twelve (12) inches to approximately fifteen (15) inches. Marking 18 preferably overlays and/or contacts circle 20.

First side 12 can also include a second marking 22 that includes a third indicia and a fourth indicia that are second graphics with defined locations on mat 10. Each second graphic defines a centerline that is positioned outside of the centerline of the first and second indicia of marking 18. The second graphics of marking 22 are preferably positioned a distance X″ apart. In this preferred embodiment, X″ is approximately three and one-half (3½) inches to approximately six (6) inches equidistant from first central axis-Y. The second graphics for marking 22 can include symbols, one or more lines or line segments or representations of hands or hand coverings such as gloves. The second graphics for marking 22 are preferably aligned with axis-Y, but can have alternative alignments depending upon the particular application of mat 10. Marking 22 preferably overlays at least a portion of marking 18 and at least a portion of circle 20.

First side 12 can further include a second circle 24 and corner markings 24. Second circle 24 is positioned within first circle 20. Second circle 24 can be concentric with or have a center that is offset from the center of first circle 20. Mat 10 also preferably defines a square shape with each corner including markings 26. The graphics of markings 26 preferably include diagonal lines that connect the sides of the defined square shape in proximity to where the edges converge, but it is understood that the graphics for markings 26 can have any shape. Further, it is understood that alternative shapes of mat 10 can define a square within their perimeter independent of the shape of edges 16.

First side 12 provides a comfortable interface for a user 2. The comfortable interface of first side 12 to user 2 can include, for example, the stability provided to user 2 standing on mat 10, user 2 using mat 10 as a reduced impact mat and user 2 using mat 2 for sit ups or other athletic activities such as yoga where there is a sizable user 2 contact with mat 10. First side 12 has a low friction surface that accommodates the sliding or slipping of mat 10 when first side 12 interfaces with an external support surface (not shown) that can be an indoor or outdoor surface such as a floor and/or floor coverings such as wood, simulated woods and engineered woods, stone, concrete, cement, tile, paint and carpet/rugs.

The dense resilient foam of the second layer has non-slip characteristics that readily fix mat 10 in position on the external support surface. In the first position, second side 14 engages and fixes mat 10 in position relative to the external support surface.

First circle 20 is located on mat 10 to accentuate the base of support position of marking 18 as well as provide an arc for range of motion for stretching and articulating exercises from the base of support position. First circle 20 is particularly advantageously sized for adult user 2 ankle and knee flexing, stretching and articulating exercises. Second circle 24 is constructed for applications that include facilitating younger users 2 to engage in a similar range of exercises.

Corner markings 26 have a similar function of agility and articulating exercises that include color coded markings 26 to further accentuate hand or foot touch exercises primarily for younger, special, or rehabilitation type stretching, agility and developmental type exercising.

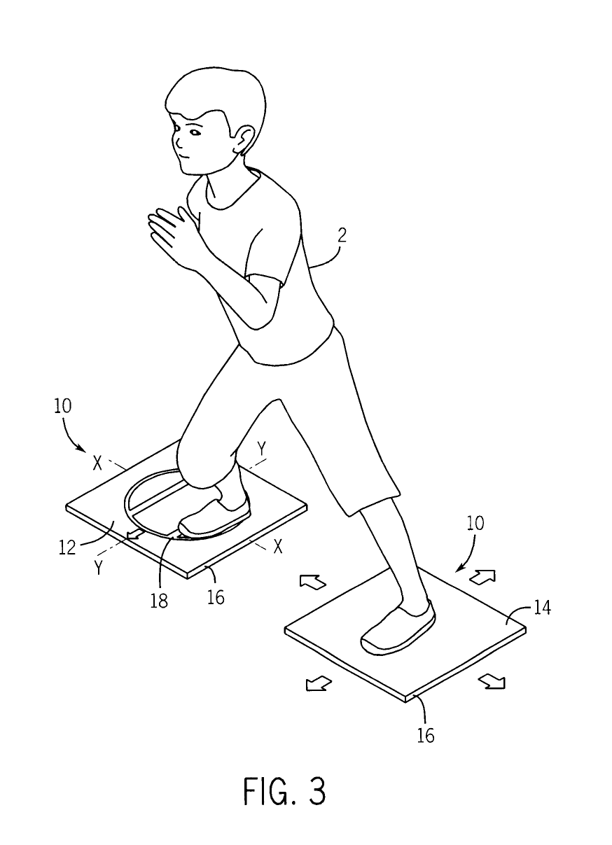

Referring now to FIG. 3, in an alternative embodiment of first layer 12 of exercise mat 10, marking 18 can be graphics can be a single line. In this instance, the first indicia and second indicia of marking 18 are located as chords to first circle 20. A combination of mats 10 are shown that includes a first mat 10 and a second mat 10. The first mat 10 is in a first position with first layer 12 directed away from and a second layer 14 (See FIG. 1) directed towards the external support surface. The second mat 10 is in a second position with second layer 14 (See FIG. 1) directed away from and the first layer 12 directed towards the external support surface. As described previously, the first layer 12 of second mat 10 can readily slide on the external support surface and the second layer 14 of first mat 10 is fixed in position on the external support surface.

User 2 is standing with one foot on first mat 10 in the first position and the other foot on second mat 10 in the second position. In this exemplary figure, the right foot of the user is positioned on first side 12 of the first mat 10 that is fixed in position and the left foot of user 2 is positioned on the second side 14 of the second mat 10 that can slide in any direction on the external supporting surface. In this combination of mats 10, user 2 can extend and stretch individual limbs in contact with mat 10 in the second position relative to fixed mat 10 in the first position. This type of exercise can emphasize and/or develop agility and balance control. In addition, this combination of mats 10 can be used for core training of the torso wherein, for example, user 2 can place their legs on mat 10 in the first position and place their hands on mat 10 in the second position. By sliding mat 10 in the second position away from and towards mat 10 in the first position, user 2 can selectively exercise abdominal, back, arm and leg muscles.

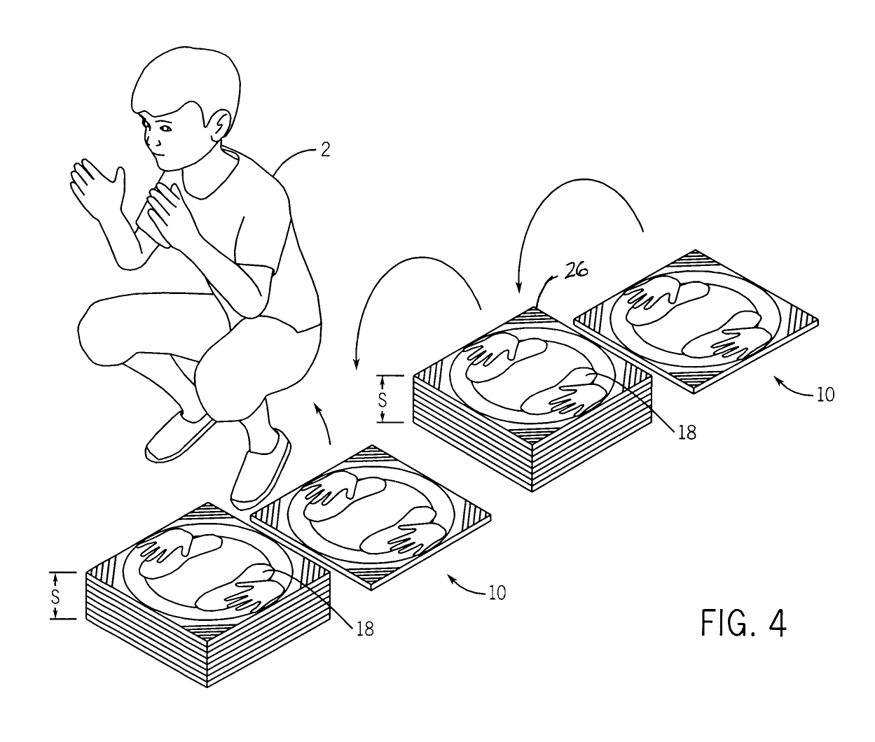

As shown in FIG. 4, in this one exemplary combination of mats 10, a plurality of mats 10 are positioned in a line as single mats 10 and in stacks of mats 10. The stacked mats are stacked to height of “S” mats. Mats 10 in the preferred embodiment that includes a square shape with fifteen (15) inch sides and with approximately a one-half (½) inch thickness have been successfully tested in stack of up to approximately thirty (30) mats 10 and/or approximately fifteen (15) inches in height. Mats 10 are specifically configured to have a non-slip interface between first layer 12 of first mat 10 and the second layer 14 of second mat 10 when mats 10 are stacked. The height “S” of any one stack of mats, however, can vary depending upon the dimensional and structural configuration of mats 10. Thus, it is envisioned that mats 10 can be configured to be stacked at heights “S” greater than fifteen (15) inches. The height “S” limitation of a given stack of mats can vary depending upon the age of user 2, skill level and other related factors.

Users 2 can leap onto or from stacks of mats 10 due to the non-slip second layer 14 (See FIG.

1) interface with first layer 12 of mats 10. The density of construction of the second layer of mat 10 provides the structural support necessary for most exercise routines. Thus, mats 10 can be readily stacked vertically to at least the predetermined limits described above and remain a stable structure. As shown, stacked mats 10 can be leaped onto or leaped from the top of similar to a plyometric or other stair step type device. Markings 18 and 26 assist users 2 in identifying their target area for landing onto one or mats 10. More specifically, marking 18 identifies the base of support as a target for landing and leap off from mat 10.

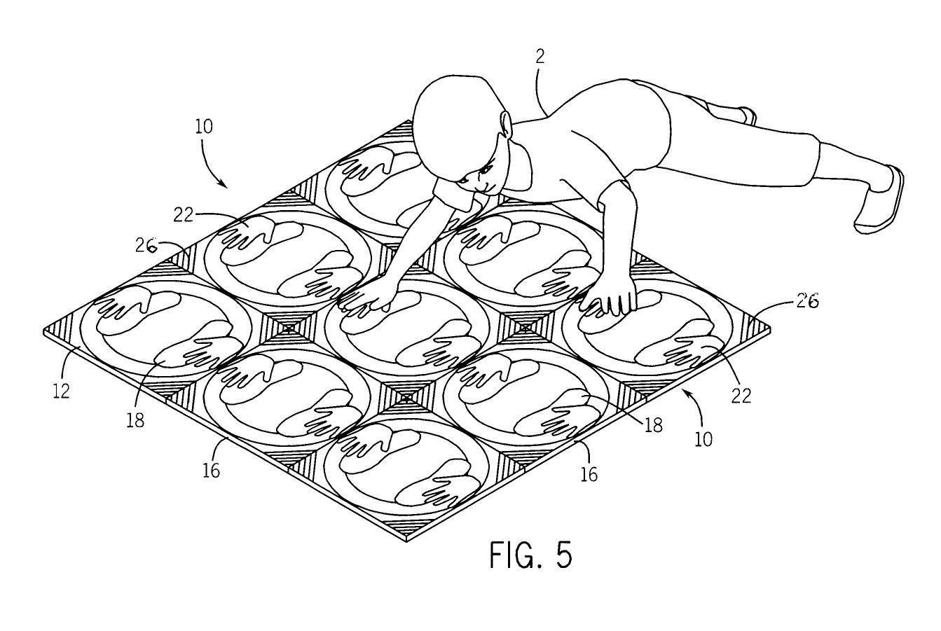

Referring now to FIG. 5, mats are positioned with edges adjoined together in a horizontal array to define a continuous arrangement of mats 10. Mats 10 are in the first position and are fixed relative to the external support surface. As shown, mats 10 are in a square arrangement that is three (3) mats 10 wide and three (3) mats 10 deep. Mats 10 in this type of arrangement can be in one or more horizontal layers or alternatively a mixture of single mats 10 and vertically stacked mats 10.

As shown, user 2 is in a push-up type position with hands positioned on mats 10 and feet located on the external support surface. In this arrangement of mats 10, user 2 can be doing a range of activities that include agility training in which the hands of user 2 are directed to different mats, or for example, to differently colored corner markings 24 of one mat 10 as hand related balance and agility training in combination with torso strengthening.

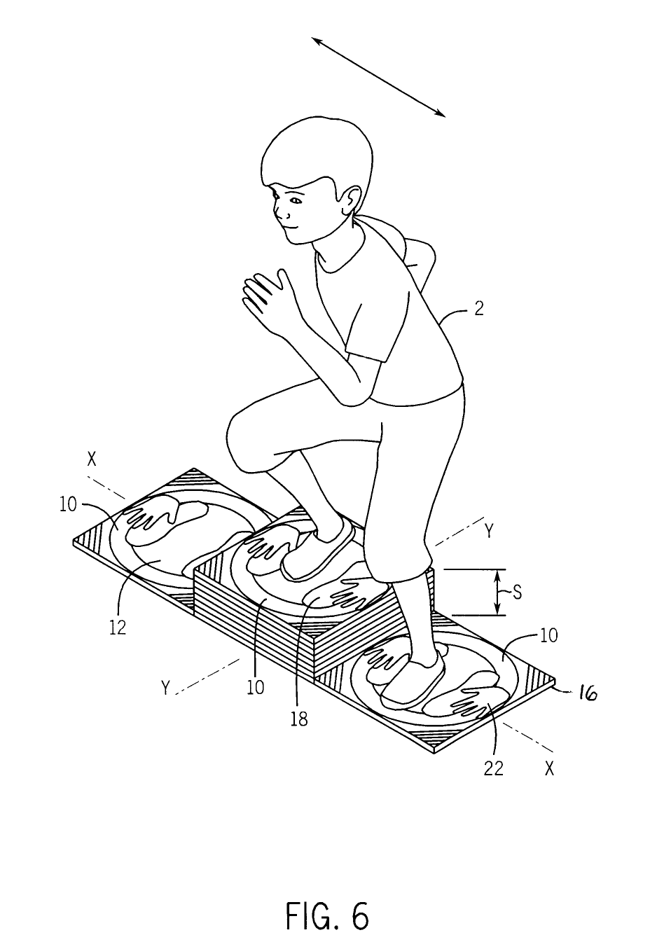

Referring now to FIG. 6, a row of three mats 10 positioned with side edges 16 adjoined are alternately a single mat 10, a plurality of stacked mats 10 and a single mat 10. The number of stacked mats 10 can vary depending upon a given situation. For example, impact loads for a given step or landing can be decreased by stacking an increased number of mats 10. Similarly, the ability to vary the height “S” of a given stack of mats 10 by the height of edge 16 of a single mat 10 can advantageously accommodate varying rates of progression of different users during exercise regimens or training

In this instance, user 2 is stepping up laterally onto a stack of mats 10. User 2 can alternatively move across to the mat 10 on the opposite side of the stack of mats 10 or return to down onto the single mat 10 on which user 10 is presently standing. User 2 can be alternatively aligned to step in the anterior and posterior directions over mats 10. One of the key advantages of mats 10 is the ability to adapt the height “S” and number of stacked mats to meet the particular needs of a given group of users 2. Mat 10 can be readily adapted in external dimensions as well as markings 18 and 22 for example for use with pre-school age children, school age children, adults and for rehabilitation and special children.

In the preceding specification, the present disclosure has been described with reference to specific exemplary embodiments thereof. It will be evident, however, that various modifications, combinations and changes may be made thereto without departing from the broader spirit and scope of the invention as set forth in the claims that follow. For example, it is understood that mat 10 can be operatively employed in alternative settings such as, for example, for strength training, agility training and confidence building and that these exercise regimens can be readily adapted to physical rehabilitation special children applications. Thus, the embodiments described herein can be applied or combined as novel features between the embodiments described herein. The drawings and specification are accordingly to be regarded in an illustrative manner rather than a restrictive sense.

What is claimed is:

1. An exercise mat that comprises:
a first side and an opposed second side, the first side and second side connected by at least one side edge, the first side has a surface constructed to slip when interfacing with an external support surface and the second side has a non-slip surface, the second side non-slip when positioned to interface with the external support surface and the second side non-slip when positioned to interface with the first side of another mat;
the mat has external dimensions that are suitable for being portable and carried by a single hand;
a first marking on the first side, the marking defines a base of support, the first marking includes a first indicia and a second indicia, the first and second indicia positioned approximately equidistant from and on opposing sides of a first central axis of the mat, the first and second indicia define elongate shapes, a center of the first indicia and a center of the second indicia approximately six inches to approximately eight inches apart, the first indicia indicating a position for a left foot and the second indicia indicating a position for a right foot on the mat when in the base of support position, a second centrally aligned axis of the mat perpendicular to the first central axis, the first and second indicia approximately aligned with the first central axis and the center of the first and second indicia intersected by the second central axis;
a circle on the first side of the mat, the circle has a center aligned with the intersection of the first central axis and second central axis, a circumference of the circle is in proximity to the side edges;
a second marking on the first side, the marking includes a third indicia and a fourth indicia positioned approximately equidistant from and on opposing sides of the first centrally aligned axis of the mat, the indicia approximately located in proximity to the edge of the mat and outside of the mat and a center of the third indicia and a center of the fourth indicia positioned a greater distance from the first central axis than the centers of the first indicia and second indicia.

2. The exercise mat of claim 1 that further includes a second circle located within the first circle.

3. The exercise mat of claim 1, wherein the mat has dimensions and weight that is hand portable.

4. The exercise mat of claim 1, wherein the mat includes corners and the corner include markings suitable for use in agility training

5. The exercise mat of claim 1, wherein a plurality of mats can be stacked on top of one another and the stacked mats are suitable for use as a step in exercises.

6. The exercise mat of claim 1, wherein a plurality of mats can be stacked on top of one another and the stacked mats are suitable for jumping onto and jumping off of during exercises.

7. The exercise mat of claim 1, wherein the mat has a flat planar square shape.

8. The exercise mat of claim 1, wherein the mat has dimensions between opposing side edges and the dimensions between the opposing side edges range between approximately twelve inches and approximately twenty-four inches.

9. An exercise mat that comprises:
a first side and an opposed second side, the first side and second side connected by at least four side edges, the first side has a surface constructed to slip when interfacing with an external support surface and the second side has a non-slip surface, the second side non-slip when positioned to interface with the external support surface and the second side non-slip when positioned to interface with the first side of another mat, each side edge has a length between approximately twelve inches and approximately twenty-four inches;
a first marking on the first side, the marking defines a base of support, the first marking includes a first indicia and a second indicia, the first and second indicia positioned approximately equidistant from and on opposing sides of a first central axis of the mat, the first and second indicia define elongate shapes, a center of the first indicia and a center of the second indicia approximately six inches to approximately eight inches apart, the first indicia indicating a position for a left foot and the second indicia indicating a position for a right foot on the mat when in the base of support position, a second centrally aligned axis of the mat perpendicular to the first central axis, the first and second indicia approximately aligned with the first central axis and the center of the first and second indicia intersected by the second central axis;
a circle on the first side of the mat, the circle has a center aligned with the intersection of the first central axis and second central axis, a circumference of the circle is in proximity to the side edges;
a second marking on the first side, the marking includes a third indicia and a fourth indicia positioned approximately equidistant from and on opposing sides of the first centrally aligned axis of the mat, the indicia approximately located in proximity to the edge of the mat and outside of the mat and a center of the third indicia and a center of the fourth indicia positioned a greater distance from the first central axis than the centers of the first indicia and second indicia.

5. The exercise mat of claim 9, wherein a plurality of mats can be stacked on top of one another and the stacked mats are suitable for use as a step in exercises.

6. The exercise mat of claim 9, wherein a plurality of mats can be stacked on top of one another and the stacked mats are suitable for jumping onto and jumping off of during exercises.

7. The exercise mat of claim 9, wherein the mat has a flat planar square shape.

8. The exercise mat of claim 9, wherein the mat has dimensions between opposing side edges and the dimensions between the opposing side edges range between approximately twelve inches and approximately twenty-four inches.
